(19) United States
(12) Patent Application Publication
(10) Pub. No.: US 2014/0078094 A1
(43) Pub. Date: Mar. 20, 2014

(54) CO-EXISTENCE OF TOUCH SENSOR AND NFC ANTENNA

(71) Applicant: Songnan Yang, San Jose, CA (US)

(72) Inventor: Songnan Yang, San Jose, CA (US)

(21) Appl. No.: 13/615,789

(22) Filed: Sep. 14, 2012

(51) Int. Cl. G06F 3/044

(52) U.S. Cl. 345/174

(57) ABSTRACT

When threshold values for the capacitive sensors in a touch pad are periodically updated to allow for drift in these values, the updating process may be suspended while a nearby radio antenna is transmitting. Such transmissions from an antenna that is located next to the touch pad could otherwise significantly alter the effective capacitance in these sensors and thereby make the touch pad unreliable for registering a touch. Even though the capacitance may return to normal fairly quickly after the transmission stops, the moving average technique typically used to smooth out short term variation may incorporate the period of changed capacitance and thereby extend the period of unreliability, but suspending the update process during a transmission can avoid this problem.

### BACKGROUND

Very thin notebook computers frequently have a chassis made of metal because the structural strength of the metal tends to reduce damage caused by flexing of the thin chassis in everyday use. However, most computer devices now include at least one radio and its associated internal antenna. Placing a radio antenna under a cutout in the metal may be desirable because the metal might otherwise interfere with transmissions from the antenna, especially in the case of Near Field Communications (NFC) radios, which primarily use the magnetic portion of the electromagnetic radio waves. The cutout made to house a touch pad may be used for this purpose because it's approximately the right size.

A modern touch pad generally consists of an array of capacitive touch sensors. A threshold value for each sensor may be set and stored in the touch pad's memory during system boot up. The readings on the capacitive sensor array may then be continuously compared to these threshold values to determine whether a touch event on the touch pad has occurred. The threshold values for the capacitive sensors may also be periodically updated in a moving average manner to capture longer term wander of the baseline values due to environmental changes (such as temperature, humidity, surroundings, etc.).

A transmission from a nearby radio antenna may significantly change the capacitive characteristic detected by the sensors. Even if the charge returns to normal fairly soon after the transmission stops, the moving average technique for updating the threshold values may cause the recorded threshold values to return to normal more slowly, and be out of balance with the actual charge values. In addition, the higher sensor reading during a transmission might be falsely interpreted as a touch (either a palm touch if all the sensors have a sufficiently high reading, or a finger touch if only a small subset of the sensors have a sufficiently high reading). Any of these conditions can cause the touch pad to be unusable for its intended function during the transmission and/or for a period of time after a transmission. In addition to trackpad devices commonly placed near the keyboard of a notebook computer, touch screens such as those used in tablet computers and smart phones may also suffer from this same problem, since they typically use capacitive sensors.

### BRIEF DESCRIPTION OF THE DRAWINGS

Some embodiments of the invention may be better understood by referring to the following description and accompanying drawings that are used to illustrate embodiments of the invention. In the drawings:

FIG. 1A shows a communications device, according to an embodiment of the invention.

FIG. 1B shows functional components within a wireless communications device, according to an embodiment of the invention.

FIG. 2 shows a touch pad with a radio antenna located beneath it, according to an embodiment of the invention.

FIG. 3 shows a flow diagram of a method of disabling sensor values during a transmission, according to an embodiment of the invention.

FIG. 4 shows a flow diagram of a method of ignoring sensor values during a transmission, according to an embodiment of the invention.

FIG. 5 shows a flow diagram of a method of raising threshold values during a transmission, according to an embodiment of the invention.

FIG. 6 shows a block diagram of a touch pad, radio, antenna, and touch pad controller, according to an embodiment of the invention.

FIG. 7 shows a flow diagram of a method of enabling/disabling a touch pad during transmissions, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “wireless” may be used to describe circuits, devices, systems, methods, techniques, communications channels, etc., that communicate data by using modulated electromagnetic radiation through a non-solid medium. A wireless device may comprise at least one antenna, at least one radio, at least one memory, and at least one processor, where the radio(s) transmits signals through the antenna that represent data and receives signals through the antenna that represent data, while the processor(s) may process the data to be transmitted and the data that has been received. The processor(s) may also process other data which is neither transmitted nor received.

As used within this document, the term “communicate” is intended to include transmitting and/or receiving. This may be particularly useful in claims when describing the organization of data that is being transmitted by one device and received by another, but only the functionality of one of those devices is required to infringe the claim. Similarly, the exchange of data between a network controller and a mobile device (both devices transmit and receive during the exchange) may be described as ‘communicating’, when only the functionality of one of those devices is being claimed.

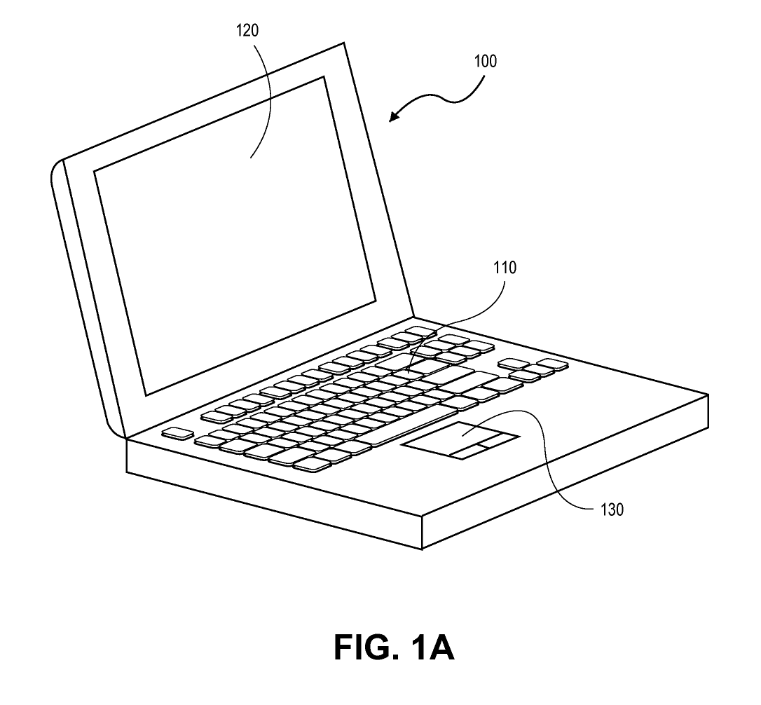

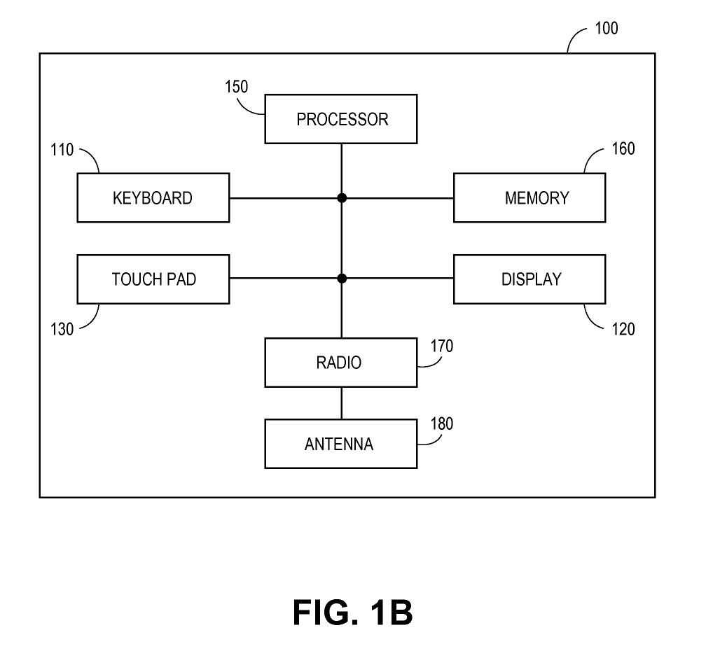

FIG. 1A shows a wireless communications device, according to an embodiment of the invention. Device 100 is shown as a typical notebook computer, with a keyboard 110, a display 120, and a touch pad 130, but device 100 may be any device, with any shape and configuration, that utilizes NFC wireless communications and has a touch pad input device. Although the touch pad 130 shown in FIG. 1A is an example of a trackpad (i.e., a small touch-sensitive area traditionally located near the keyboard and used as a replacement for a computer mouse in notebook computers), the term ‘touch pad’, as used herein, may also include a touch screen (i.e., a display screen whose surface is sensitive to localized touch), or any other capacitive sensor input device that is sensitive to touch.

FIG. 1B shows functional components within a wireless communications device, according to an embodiment of the invention. In addition to keyboard 110, display 120, and touch pad 130 as shown in FIG. 1A, wireless communications device 100 is also shown with processor 150, memory 160, radio 170, and radio antenna 180. Although device 100 is shown with one each of these items, more than one of any of these items may be included in wireless device 100.

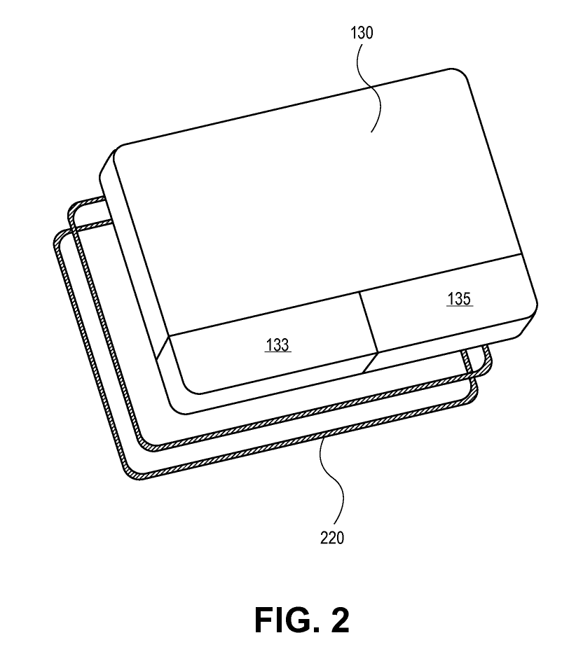

FIG. 2 shows a touch pad with a radio antenna located beneath it, according to an embodiment of the invention. Touch pad 130 is shown with two buttons 133 and 135 for additional inputs, as is common with many touch pads located near computer keyboards such as shown in FIG. 1A, although buttons and a similar location should not be seen as limitations on the various embodiments of the invention. In some embodiments, touch pad 130 may be a touch pad assembly containing logic to perform many of the operations described herein. The logic may assume any feasible form, such as but not limited to: 1) discrete circuitry, 2) a state machine, 3) programmable instructions, 4) etc. Antenna 220 is shown as a loop antenna with multiple loops, although multiple loops and/or the loop configuration should not be considered limitations on the various antenna configurations. Antenna 220 is also shown with an overall planar rectangular shape, although some antennas may be non-planar, and even planar antennas may have other shapes, such as but not limited to square, circular, oval, etc. The plane of antenna 220 is shown parallel to the plane of the touch pad 130, which would be considered a best mode for antennas with a planar shape that are expected to transmit through the opening in the chassis that was created for the touch pad, but other configurations may also be used. In some embodiments, the antenna and touch pad may be built into a single structure. One way to accomplish this may be to create the antenna as a trace on a circuit board which forms one of the layers of a multi-layer touch pad assembly, although various embodiments of the invention are not limited in this respect.

The touch area of the touch pad may be comprised of an array of capacitive sensors. When a human finger touches the touch pad, the proximity of the biological material in the finger may change the sensed capacitance of the sensors within the touched area, and this change may then be interpreted as a touch. Because small variations in capacitance may be normal even without a touch, the amount of change may need to exceed a specified minimum amount before a touch is to be interpreted.

For each sensor, a value that is presumed to be the ‘non-touch’ reference value may be previously recorded and then compared with the current value to determine if the change is significant enough to be reliably interpreted as a touch. Because the steady state value of capacitance in each sensor may drift due to temperature, humidity, age, proximity of the user's hand, etc., the current value of capacitance at each sensor may be periodically measured and recorded, and the reference value updated. To eliminate short term error in this process, a moving average of such measurements, taken over a period of time, may be used to determine the current reference value for each sensor. For the purposes of this document, such reference values may be referred to as ‘threshold values’. In some embodiments, at system startup a slightly different sequence may be used to create the initial threshold values, since there may be no prior history of values to depend upon.

In one embodiment, a series of sensor values may be measured for each capacitive sensor over a period of time, and all those sensor values for all the sensors may be stored in a table, with the oldest sensor values being removed to make room for the newest sensor values. The table may contain ‘x’ times ‘y’ sensor readings, where ‘x’ is the number of readings being stored, and ‘y’ is the number of sensors whose readings are being stored. For each sensor, the average may be calculated by adding up the stored sensor values and dividing the sum by ‘x’.

In another embodiment, only the threshold values may be stored. Each time a new sensor reading is measured, the associated threshold value may be updated by assuming the threshold value represents the average of the past ‘x’ number of readings and doing an incremental adjustment to it. For example, if the threshold value is based on an average of the last eight sensor values, the new threshold value may be calculated as:

(⅞ of the old threshold value)+(⅛ of the new sensor value).

This approach avoids having to maintain an ‘x’ by ‘y’ table. It may also simplify startup calculations, since the initial sensor value can be assumed as the threshold value, and all subsequent calculations can then follow the same algorithm.

These two methods of calculating the threshold values are examples. Other techniques may be used instead. The frequency of reading the sensor values, and the number of sensor values used to calculate the moving average, may be any feasible numbers. For example, a reading of all the sensor values might be taken four times per second, and a moving average of the most recent eight sensor readings might be used to calculate a threshold value. Note that these numbers are only an example used to illustrate the process, and should not be seen as a limitation on the various embodiments of the invention.

As previously mentioned, to avoid inaccuracies in detecting a touch, the amount of change determined by the comparison should exceed a specified minimum amount before a touch is to be registered. This may be handled in various ways. In one embodiment, the recorded threshold values should include the minimum difference (i.e., the moving average plus the minimum difference), so that a direct comparison with the current value can be used to determine a touch. In another embodiment, the actual moving average value may be recorded as a threshold value, and the comparison process itself detects a difference of more than the minimum difference before a touch is to be registered.

A touch may typically be simultaneously sensed by multiple adjacent sensors (a ‘cluster’ of sensors) due to the width of a human finger and the spacing of the sensors. A sliding touch may be registered when the location of a cluster moves across the touch surface over time, without an intervening absence of touch. A palm touch may be registered if the number of sensors in a cluster is significantly more than the number expected from a finger touch. In general, a palm touch is inadvertently caused when the user accidently lays his or her palm across the touch pad. It may generally be considered an error by the user, and ignored by the system. In general, a finger touch may be inferred when a suitably small subset of all the sensors simultaneously register a touch, while a palm touch may be inferred when a suitably large subset of all of the sensors simultaneously register a touch. The percentage of sensors that distinguish a finger touch (e.g., <m %) and a palm touch (e.g. >n %) may be a design choice, and in general do not affect the determination of ‘threshold values’, as that term is used in this document.

In many embodiments, the spacing between the touch pad 130 and antenna 220 in FIG. 2 may be small (e.g., less than 3 millimeters). Because of this proximity, a transmission from the antenna may significantly change the charge in the sensors during the transmission, and any sensor reading taken during that time may result in false threshold values that can persist until the moving average calculations no longer include the effects of the transmission period. In addition, the increased sensor values at the beginning of a transmission may be falsely interpreted as a touch. To avoid these issues, various techniques may be used to prevent the altered capacitive values from creating problems with the touch function, such as but not limited to one or more of these techniques: 1) any sensor values that are read during a transmission may be ignored, and not used to calculate the moving average values, 2) the reading of sensor values may be disabled during a transmission, so that the periodic values are not even read during that time, 3) the threshold values may be immediately raised at the beginning of a transmission to reflect the increased sensor values, and lowered to the pre-transmission values immediately after the transmission. Techniques 1) and 2) assume the touch pad will be unusable during the transmission, while technique 3) attempts to make the touch pad usable during the transmission. All these techniques rely on knowing when a transmission is being made from the antenna.

If transmissions from the antenna are being controlled or monitored by a device that also controls the touch pad, this device may provide the necessary knowledge of when transmissions occur and use that knowledge to suppress or ignore periodic readings of the capacitive sensor values. Alternatively, if the touch pad detects a sudden and significant change in the values of all or nearly all of the sensors, this may be interpreted as a transmission period, and any of the previously discussed techniques may be used. When the readings return to the pre-transmission range, the transmission may be assumed to be over and normal processing of the touch pad inputs may resume. This sequence may also be used to ignore a palm touch, since both a palm touch and a transmission may have a similar effect on the touch sensors.

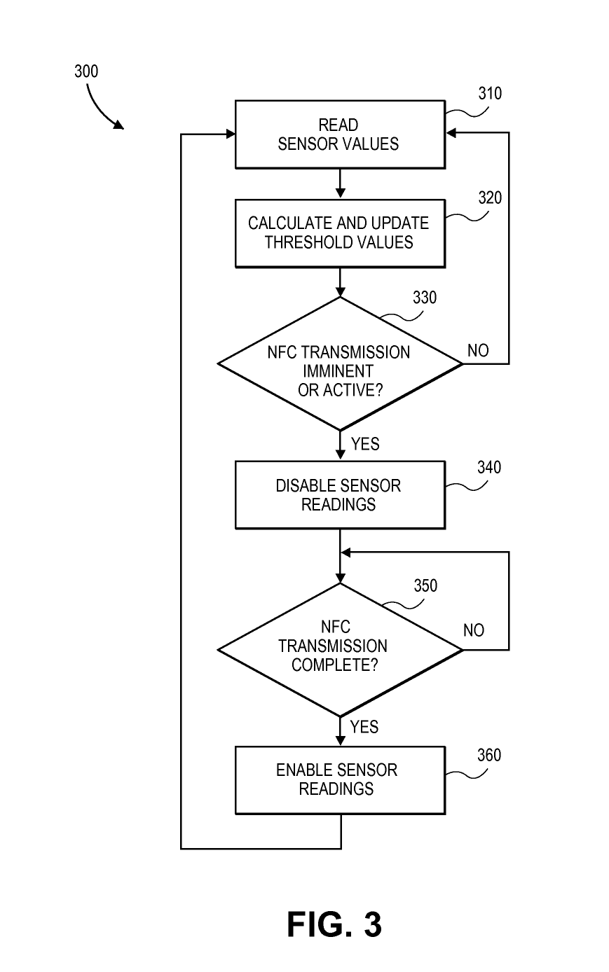

FIGS. 3, 4, and 5 show flow diagrams for various ways of handling threshold values when a transmission from a nearby NFC antenna may affect sensor inputs from a touch pad. These figures each focus on when to update the threshold values, rather than when to register a touch on the touch pad. It may be assumed that a touch on the touch pad is registered when a) the touch pad is enabled, and b) a suitably small subset of the sensors in the touch pad sense a large enough increase in capacitance over the threshold value that a touch may be inferred.

FIG. 3 shows a flow diagram of a method of disabling sensor values during a transmission, according to an embodiment of the invention. In flow chart 300, sensor values for the capacitive sensors in a touch pad are read at 310. Depending on the embodiment, these may be stored for future use and/or may immediately be made available for further use. Threshold values may then be computed at 320, using some form of moving average computation incorporating the results of several sets of previous sensor values, and the current threshold values may be stored for subsequent comparison. Various ways of calculating the threshold values have been previously discussed in this document.

At 330, it may be determined whether a transmission from the NFC antenna is either imminent or is actively in progress, or whether no such transmission is imminent/active. If a transmission is not active or imminent, the device may continue to read sensor values at 310, and compute and update new threshold values at 320. The loop through 310, 320, and 330 may continue as long as no NFC transmissions are determined to be taking place or anticipated to take place immediately.

The determination of an NFC transmission may be made in any of several ways, including but not limited to:

1) A module in the device may control NFC transmission and therefore have advance knowledge that a transmission is about to take place, or current knowledge that a transmission is in progress. This module may either control the subsequent actions described in flow diagram 300, or trigger another module to control them. In some embodiments, a peripheral control hub (PCH) may be used to control transmissions and also control the touch pad.

2) A module in the device may monitor for NFC transmission and therefore obtain current knowledge that a transmission is in progress. This module may either control the subsequent actions described in flow diagram 300, or trigger another module to control them. This module may monitor for a transmission in several ways, such as but not limited to: a) monitor a signal that indicates whether a transmission is in progress, b) examine an indicator in a register or memory location that indicates whether a transmission is in progress, c) receive an interrupt that indicates whether a transmission is being started and/or terminated.

3) Readings from most or all of the sensors may suddenly become large enough to indicate either a transmission from the nearby antenna or a palm touch. If both events cause similar readings from the capacitive sensors, and both events are responded to in the same way, it may not matter whether the system can distinguish between the two events.

If it's determined at 330 that a transmission is imminent or is in progress, further sensor readings may be disabled at 340. This may be accomplished in several ways, such as but not limited to: 1) disabling the entire touch pad, 2) stopping the read function, 3) performing the reads but not keeping or using the sensor values, 4) etc. Sensor readings may remain disabled as long as the NFC transmission continues.

Sensor reading may remain disabled until it is determined at 350 that the NFC transmission has stopped. This determination may be made in various ways, such as but not limited to using the same techniques listed above to determine if a transmission is imminent or in progress. Once it has been determined that the NFC transmission has stopped, sensor readings may be re-enabled at 360, and the read/compute/update sequence may be restarted at 310-320. Since no readings were taken and/or used during the transmission, the most recent ‘x’ number of sensor values that effect the threshold calculations (where ‘x’ is the number of readings used to calculate a moving average) may naturally incorporate some values read before the transmission and some values read after the transmission, until sufficient updates have occurred to effectively exclude the sensor values read before the transmission.

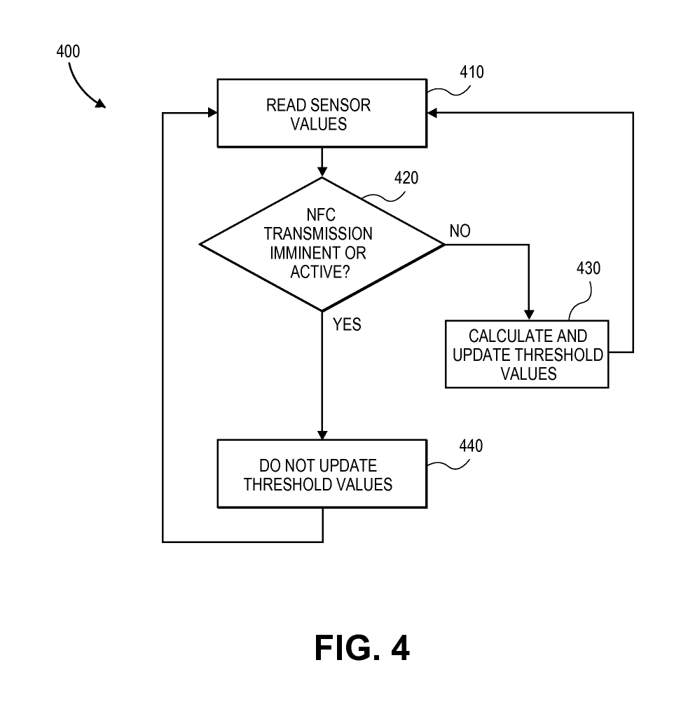

FIG. 4 shows a flow diagram of a method of ignoring sensor values during a transmission, according to an embodiment of the invention. In flow chart 400, sensor values for the capacitive sensors in a touch pad are read at 410, and may be stored for further use. At 420 it may be determined whether a transmission from the NFC antenna is either imminent or is actively in progress, or whether no such transmission is imminent/active. In some embodiments, the criteria for such a determination may be the same as described above for FIG. 3.

If a transmission is not imminent or active, at 430 the stored sensor values may be used to calculate threshold values, and the newly calculated threshold values may used to update (i.e., replace) the previous threshold values. The flow may then return to 410 to repeat the periodic process of reading and updating in the loop 410-420-430. This cycle may continue as long as there are no transmissions from the antenna.

However, once a transmission from the antenna is detected or determined to be imminent, the calculation and updating of threshold values may be halted at 440. As long as the NFC transmission continues, the flow may continue to loop through 410-420-440. Even though the reading of sensor values at 410 may be continued during this loop, these new sensor values may not be used to compute/update the threshold values.

Once the transmission stops, as determined at 420, the device may resume using new sensor values to compute and update the threshold values. In one embodiment, new threshold values are calculated based on the most recently stored threshold value (which was based only on pre-transmission sensor readings), and the most recent sensor value, in which case any readings taken during the transmission are automatically ignored.

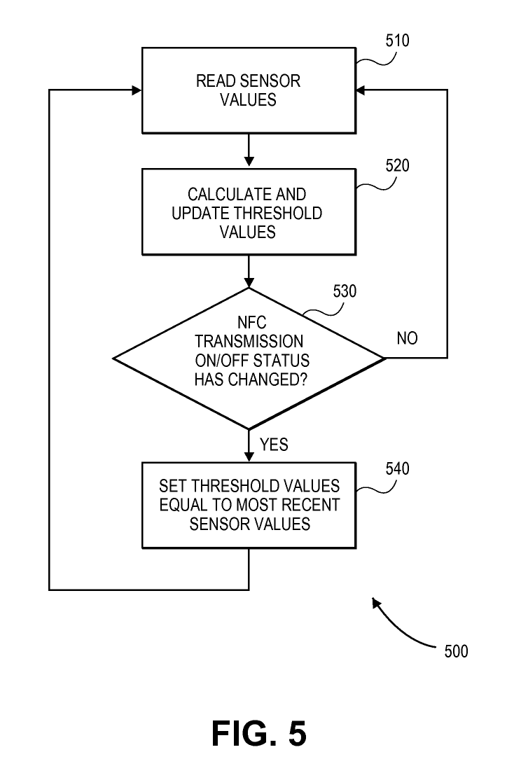

FIG. 5 shows a flow diagram of a method of raising threshold values during a transmission, according to an embodiment of the invention. In flow diagram 500, sensor values from the multiple capacitive sensors may be read at 510. At 520, new threshold values may be calculated and the threshold values may be updated by replacing the previous threshold values with the newly calculated threshold values. This process involves the standard way of updating, in which any change to the threshold values is incremental in nature due to the moving average method of calculating new threshold values. At 530, it may be determined whether the transmission status of a nearby NFC antenna has changed between transmitting and not transmitting (i.e., either from transmitting to not transmitting, or from not transmitting to transmitting). For example, if the transmission was previously off but is now on, the effect of radiation from the antenna may be assumed to have immediately and significantly increased the value of capacitance sensed by all, or at least most, of the sensors. Since this condition may be expected to continue as long as the transmission is active, this may be interpreted as a reason at 540 to replace the previously calculated threshold values with threshold values equal to the most recent sensor values.

When the flow moves from 540 to 510, the next sensor values that are read at 510 may be assumed to be high if the transmission is still active. In such a case, new sensor values may be processed as usual at 520, with the newly calculated threshold values remaining fairly close to the values generated at 540. In this way, if the new sensor values are close to the currently high threshold values, no touch is inferred, even though the sensor values may be significantly higher than their long term average values. On the other hand, if a subset of the sensors now indicate sensor values that are higher than the already-high threshold values, a touch may be inferred, even though the ongoing transmission has significantly affected the steady-state value of the sensors.

As long as the on/off transmission status of the antenna remains unchanged, control may loop through 510-520-530-510 in the usual manner, with a touch being inferred whenever a subset of the sensors indicate sensor values that are sufficiently higher than the threshold values. However, if the determination at 530 indicates a change in the transmission status, control may move to 540, where again the threshold values may be set to the most recent sensor values rather than being calculated in the usual incremental manner. For example, if the antenna was previously transmitting, but is now not transmitting, the threshold values may be immediately set to their most recent post-transmission values, which would be the values normally seen when the antenna was not transmitting and no touch was occurring. Control may then return to 510, and the processing at 510-520-530-510 may resume as it was before the transmission started, with both sensor values and threshold values at their normal no-transmission levels.

Depending on the timing, it is possible that sensor values may not have completed their transition when a change in the transmission on/off status is detected. In this case, the most recent sensor values may not be an accurate indication of what the new threshold values should be. To address this possibility, in some embodiments the change process of operations 530-540 may be implemented over two (or more) consecutive sensor reading cycles. In that way, if the first pass through 540 produces incorrect threshold values, the subsequent pass through 540 will correct it.

The flow of FIG. 5 may also be useful when rejecting a palm touch. Since a palm touch may affect many of the sensors (too many to be interpreted as a finger touch), the resulting sudden increase in this many sensor values may be handled in the same manner as the sudden activation of a transmission from the antenna.

In some designs, radiation from the NFC antenna may interfere with the interface between the touch pad and the controller that controls the touch pad. For example, an I2C interface may be subject to disruption by transmissions from the antenna. In such conditions, the touch pad may be disabled during the transmissions.

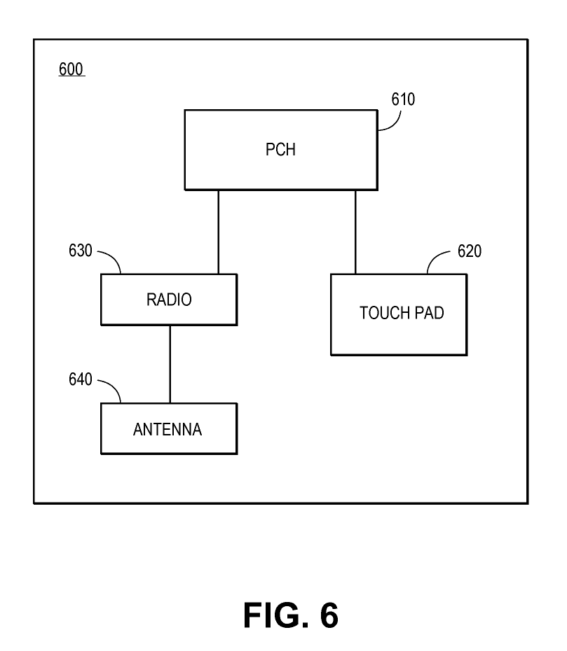

FIG. 6 shows a block diagram of a touch pad, radio, antenna, and touch pad controller, according to an embodiment of the invention. In module 600, a single controller 610 is shown to interface with both the touch pad 620 and with the radio 630. Controller 610 is labeled as a peripheral control hub (PCH), but this should not be seen as a limitation on either the name or the functionality of the controller. In some embodiments, controller 610 may be configured to control when touch pad 620 is enabled or disabled, and also to control when radio 630 does and does not transmit through antenna 640. In this manner, a single module may be able to disable the touch pad when the radio is transmitting, and enable the touch pad when the radio is not transmitting.

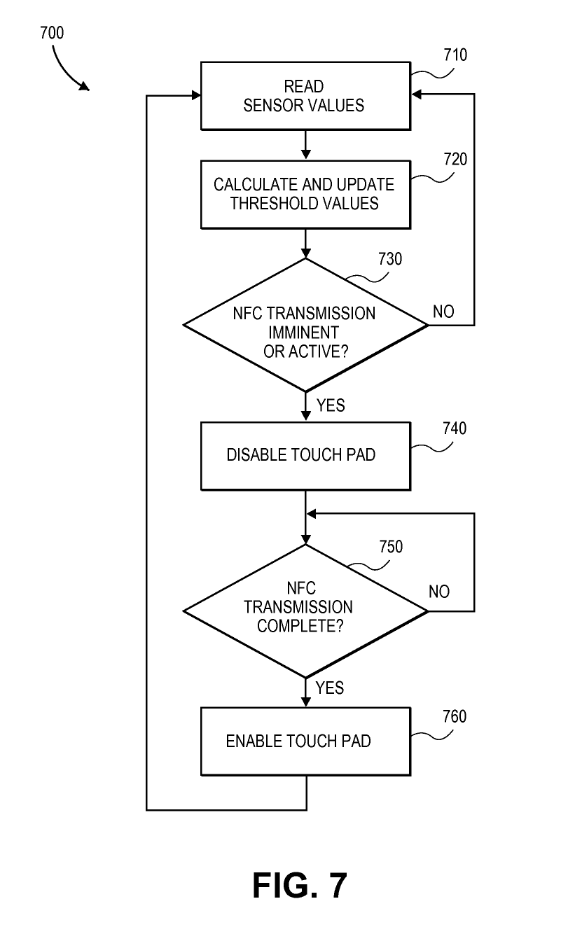

FIG. 7 shows a flow diagram of a method of enabling/disabling a touch pad during transmissions, according to an embodiment of the invention. In flow chart 700, sensor values for the capacitive sensors in a touch pad are read at 710. Depending on the embodiment, these may be stored for future use and/or may immediately be made available for further use. Threshold values may then be computed at 720, using some form of moving average computation incorporating the results of several sets of previous sensor values, and the current threshold values may be stored for subsequent comparison. Various ways of calculating the threshold values have been previously discussed in this document.

At 730, it may be determined whether a transmission from the NFC antenna is either imminent or is actively in progress, or whether no such transmission is imminent/active. If it is neither, the device may continue to read sensor values at 710, and compute and update new threshold values at 720. The loop through 710, 720, and 730 may continue as long as no NFC transmissions are determined to be taking place or anticipated to take place immediately.

The determination of an NFC transmission may be made in any of several ways, including but not limited to the techniques described for FIG. 3.

If it's determined at 730 that a transmission is imminent or is in progress, the touch pad may be disabled at 740. By disabling the touch pad, no inputs from the touch pad may be received by the touch pad controller, so no corruption of those inputs may occur.

The touch pad may remain disabled until it is determined at 750 that the NFC transmission has stopped. This determination may be made in various ways, such as but not limited to using the same techniques listed above to determine if a transmission is imminent or in progress. Once it has been determined that the NFC transmission has been completed, the touch pad may be re-enabled at 760, and the read/calculate/update sequence may be restarted at 710-720. Since the touch pad was disabled during the transmission, no corrupted commands to the touch pad will have been received by the touch pad, and no corrupted inputs from the touch pad to the controller will have been received by the controller, during the transmission.

The foregoing description is intended to be illustrative and not limiting. Variations will occur to those of skill in the art. Those variations are intended to be included in the various embodiments of the invention, which are limited only by the scope of the following claims.

What is claimed is:

1. A wireless communications device having a processor, a memory, a radio antenna for Near Field Communications (NFC), and a touch pad having a plurality of touch sensors, the device configured to perform these operations for each of multiple ones of the sensors:
a) periodically read a sensor value from the touch sensor;
b) determine a moving average value for a quantity of the periodically read sensor values, and store the moving average value as a threshold value;
c) repetitively update the threshold value by repetitively performing operations a) and b) over time;
d) compare a next sensor value with the threshold value to determine whether to register a touch on the touch pad; and
e) repeat operations a) through d) while no signal is transmitted from the antenna;
wherein the device is further configured to start and stop transmitting a signal from the antenna, and to halt at least one of operations a) through c) during said transmission of the signal.

2. The device of claim 1, wherein the device is configured to halt operation c) during the transmission.

3. The device of claim 1, wherein the device is configured to halt operation b) during the transmission.

4. The device of claim 1, wherein the device is configured to halt operation a) during the transmission.

5. The device of claim 1, wherein the device is configured to resume updating the threshold value after determining the transmission has stopped.

6. The device of claim 1, wherein the device is configured to halt operations a), b), and c) by disabling the touch pad during the transmission.

7. The device of claim 6, wherein the device is configured to resume operations a), b), and c) by enabling the touch pad after the transmission stops.

8. The device of claim 1, wherein a plane of the antenna is parallel to a plane of the touch pad.

9. A touch pad assembly for a wireless communications device using Near Field Communications, the touch pad assembly comprising:
a touch surface having multiple capacitive sensors arranged to sense a touch on the touch surface;
logic configured to periodically read a capacitance value for each of the multiple capacitive sensors and to determine a moving average of the values for a multiple number of previous readings for each of the multiple capacitive sensors; and
an input to determine when a nearby Near Field Communications (NFC) antenna is transmitting;
wherein the logic is to periodically update the moving average for each sensor, and is to halt said updating the moving average when the antenna is transmitting.

10. The touch pad assembly of claim 9, wherein the logic is configured to halt the updating by stopping operation of the touch pad.

11. The touch pad assembly of claim 9, wherein the logic is configured to halt the updating by stopping the periodic updating of the moving average.

12. The touch pad assembly of claim 9, wherein the logic is configured to resume updating the moving average after the antenna stops transmitting.

13. A method of reducing interference of a touch pad by a co-located radio antenna, comprising:
a) periodically read a sensor value from a sensor in the touch pad;
b) determine a moving average value for a quantity of the periodically read sensor values, and store the moving average value as a threshold value;
c) repetitively update the threshold value by repetitively performing operations a) and b) over time;
d) compare a next sensor value with the threshold value to determine whether to register a touch on the touch pad; and
e) repeat operations a) through d) while no signal is being transmitted from the antenna;
f) start and stop transmissions from the radio antenna;
g) halt at least one of operations a) through c) during said transmission of the signal.

14. The method of claim 13, further comprising halting operation c) during the transmission.

15. The method of claim 13, further comprising halting operation b) during the transmission.

16. The method of claim 13, further comprising halting operation a) during the transmission.

17. The method of claim 13, further comprising resuming updating the threshold value after determining the transmission has stopped.

18. A computer-readable non-transitory storage medium that contains instructions, which when executed by one or more processors result in performing operations comprising:
determining a transmission from a radio antenna is about to start;
disabling a touch pad after said determining the transmission is about to start;
determining the transmission has stopped; and
enabling the touch pad after said determining the transmission has stopped.

19. The medium of claim 18, wherein the operations further comprise causing the transmission to start and stop.

20. A wireless communications device having a processor, a memory, a radio antenna for Near Field Communications (NFC), and a touch pad having a plurality of touch sensors, the device configured to perform these operations for each of multiple ones of the sensors:
a) periodically read a sensor value from the touch sensor;
b) determine a moving average value for a quantity of the periodically read sensor values, and store the moving average value as a threshold value;
c) repetitively update the threshold value by repetitively performing operations a) and b) over time;
d) compare a next sensor value with the threshold value to determine whether to register a touch on the touch pad;
e) determine whether a transmission from an NFC antenna is transitioning between a transmit status and a non-transmit status; and
f) if the transmission status is transitioning, temporarily replace operation b) with an operation of storing a most recent sensor value as the threshold value;
wherein operation f) is limited to a specific number of consecutive updates when the transmission status is determined to transition.

21. A computer-readable non-transitory storage medium that contains instructions, which when executed by one or more processors result in performing operations comprising:
a) periodically reading a sensor value from the touch sensor;
b) determining a moving average value for a quantity of the periodically read sensor values, and storing the moving average value as a threshold value;
c) repetitively updating the threshold value by repetitively performing operations a) and b) over time;
d) comparing a next sensor value with the threshold value to determine whether to register a touch on the touch pad;
e) determining whether a transmission from an NFC antenna is transitioning between a transmit status and a non-transmit status; and
f) if the transmission status is transitioning, temporarily replacing operation b) with an operation of storing a most recent sensor value as the threshold value;
wherein operation f) is limited to a specific number of consecutive updates when the transmission status is determined to transition.
